(19) United States
(12) Patent Application Publication
(10) Pub. No.: US 2022/0253033 A1
(43) Pub. Date: Aug. 11, 2022

(54) Method and System for Implementing Event Rules for Maintenance Relevant Events in a Plurality of Machines

(71) Applicant: Siemens Aktiengesellschaft, Muenchen (DE)

(72) Inventors: Ioana STEFAN, Brasov (RO); Maja MILICIC BRANDT, München (DE); Silvio BECHER, München (DE)

(21) Appl. No.: 17/627,271

(22) PCT Filed: Jul. 15, 2020
(86) PCT No.: PCT/EP2020/069995

§ 371 Date: Jan. 14, 2022

(30) Foreign Application Priority Data
Jul. 18, 2019 (EP) 19186889.2

(51) Int. Cl. G05B 19/042

(52) U.S. Cl. CPC G05B 19/0428; G05B 2219/24001

(57) ABSTRACT

Method for implementing event rules for maintenance relevant events in a plurality of machines, wherein the method utilizes a computer system containing a common central configurator, and wherein the machines are connected to the common central configurator to transfer data, where the method includes defining a maintenance relevant event for a certain class of machines by using the common central configurator, sending the event rule to an edge device of at least one machine of this class, preferably to edge devices of all machines of this class, where the edge device forms part of the computer system, and storing the event rule in the edge device and the common central configurator such that it is possible to implement event rules in a plurality of similar machines without having to implement those event rules on every single machine independently.

### CROSS-REFERENCE TO RELATED APPLICATIONS

This is a U.S. national stage of application No. PCT/EP2020/069995 filed 15 Jul. 2020. Priority is claimed on European Application No. 19186889 filed 18 Jul. 2019, the content of which is incorporated herein by reference in its entirety.

### BACKGROUND OF THE INVENTION

### 1. Field of the Invention

The present invention relates to computer program code anda method for implementing event rules for maintenance relevant events in a multitude of machines, where the method uses a computer system.

With the plurality of machines, it should be understood there are machines that all have the same components or that only have some same major components and other components are different. Machines with the same major components can be treated as one class of machines. Machines here especially include physical machines, such as motors, pumps, machine tools such as computerized numerical control (CNC) machines, which normally have machine controllers implemented in hardware and/or software.

### 2. Description of the Related Art

Machines have become more and more complex. A machine can comprise software and/or hardware components with different operation lifetimes. Accordingly, it is necessary to perform maintenance activities to maintain a machine in an operable state. Maintenance activities comprise, for instance, the replacement of failed or worn-out components of the machine. Further, the machine can comprise resources that are consumed during operation of the machine. For instance, a machine can comprise a reservoir or container for lubrication fluids that are used to lubricate components of the machine. Accordingly, the maintenance of a machine is in itself a complex process that is performed with the goal to avoid a breakdown of the machine or to prohibit performance of the machine from decreasing.

WO 2019/016148 A1 discloses a method and system for automatic maintenance of a machine comprising the steps of receiving at least one maintenance relevant event from a controller of the machine, augmenting the received event with the event's machine context read from a machine maintenance ontology, matching the event's machine context with maintenance rules to generate at least one maintenance task comprising an associated task description, and providing a maintenance schedule for the machine assigning the generated maintenance task to suitable maintenance executing entities based on the task description of the respective maintenance task.

The maintenance relevant event, for example, can be a machine disruption event indicating a disruption of at least one machine component of the machine, and/or a machine wear-out event indicating a wearout of at least one machine component of the machine, and/or a time-triggered maintenance event. An event can be generated by a machine controller by evaluating sensor data from sensors monitoring a behavior and/or operational state of machine components of the machine. The generated maintenance relevant event can comprise a time stamp and machine component indicators indicating affected machine components affected by the reported event.

If a multitude of machines of one class must be maintained, then the maintenance relevant events must be implemented in the controller of each machine, which is very laborious. Additionally, one has to know how to address the required data points for a certain machine, which can be controller-specific and/or machine-specific, and how to generate new events on that controller, which normally is specific for the respective PLC (programmable logic controller).

### SUMMARY OF THE INVENTION

In view of the foregoing, it is therefore an object of the present invention to provide a method for implementing event rules for maintenance relevant events in a plurality of similar machines without having to independently implement those event rules on every single machine.

This and other objects and advantages are in accordance with the invention by a method according for implementing event rules for maintenance relevant events in a multitude of machines, where the method uses a computer system containing a common central configurator, where in order the machines are connected to the common central configurator to transfer data, and where the method comprises defining a maintenance relevant event for a certain class of machines by using the common central configurator, sending the event rule to an edge device of at least one machine of this class, preferably to the edge devices of all machines of this class, where the edge deviceform part of the computer system, and storing the event rule in the edge device, and storing the event rule in the common central configurator.

Thus, for a certain class of machines the respective maintenance relevant events, in the following just named “events”, are defined only once and then the information on this event is sent to the edge device of a machine of this class of machines and stored in the edge device. The edge device is normally also connected to the machine controller of the respective machine The way how to communicate between common central configurator and the machine controllers and/or its edge devices, which controllers and/or edge devices can have different properties even for the machines of the same type, can be defined once and then used for future communication.

The term “machine” in the context of the disclosed invention can refer to a physical machine (with one or more components) or to a component of a machine.

An edge device is a computer device that provides for a machine an entry to a computer network. Edge devices are local computers that collect all machine-relevant data, including, e.g., CNC data for a CNC machine, and also programmable logic controller (PLC) data and additional machine sensor data. The edge device can at least compute and store data. The edge device enhances the capabilities of the machine and/or the machine controller because it establishes a data connection and makes computations with regard to event rules. The edge device can be a physical part of the machine, e.g., it can be situated in the same housing, or it can be physically separated from an existing machine, the latter, e.g., being the case if an existing machine is subsequently equipped with an edge device.

The event, for example, can be, as in the prior art, based on the usage of a machine and/or based on the condition of the machine. Condition based events are, for example, a machine disruption event indicating a disruption of at least one machine component of the machine, and/or a machine wear-out event indicating a wear-out of at least one machine component of the machine, or the excess of a given threshold. Usage based events are, for example, that a given operational time of the machine or a machine component has been reached, e.g., for a CNC machine 500,000 clamping cycles of the spindle. Or the event could also be a time-triggered maintenance event, irrespective of usage and condition of the machine, such as a certain absolute time period. An event can be generated by the machine controller and/or by its edge device, by evaluating sensor data from sensors monitoring a behavior and/or operational state of machine components of the machine. The generated maintenance relevant event can comprise a time stamp and machine component indicators indicating affected machine components affected by the reported event.

The data to be transferred from the common central configurator to the machines, i.e., to their edge devices, is for example, the event rule. The data to be transferred from the machines to the common central configurator are, for example, event messages that can be data sources for other events or event rules, respectively.

When defining a maintenance relevant-event, it is possible to, at the same time, also define a corresponding maintenance rule for this event for this class of machines by using the common central configurator. These rules could also be stored in the common central configurator and can be applied by the common central configurator. However, these maintenance rules are normally stored in and applied by another entity of the computer system.

In accordance with an embodiment of the invention, the edge device is situated at or near the machine whereas the common central configurator comprises a cloud service. Near means, e.g., that the edge device has a distance to the machine of less than 100 m, normally less than 10 m. Near means, e.g., in the same building. Cloud services can be, and normally are, executed in a physical place that is far away from the physical machines to be monitored. Far away means, e.g., more than 100 m away, and/or e.g. at least in another building. Far away usually is understood as being one or more kilometers away. A cloud service is defined as the availability of computer system resources, such as data storage and computing power, to many users over the Internet. This has the advantage that new machines, i.e., their edge devices, can be added to the computer system irrespective of their location. Consequently, a plurality of machines distributed over a large physical area can be managed by the method in accordance with the invention.

In accordance with another embodiment of the invention, the edge device includes a complex event processing engine (CEP engine) which, based on the event rule and based on input data from the machine, creates an event message if the input data fulfills the event rule and sends the event message to a device that deploys a respective maintenance rule.

CEP engines are also called event correlation engines (event correlators). They analyze all events emanating from their machine, select those that fulfill the event rule for a certain event, and send a respective event message to another entity, which then deploys the respective maintenance rule. CEP engines normally do not infer new events from the predefined events, but they can relate different events with each other.

The CEP engines are deployed near the machines. In this way, the processing occurs near the sensors and only the results relating to meaningful events (event messages) are sent to the central application responsible for maintenance. The CEP engine exposes interfaces to deploy and to delete CEP statements (=event messages). By deploying an event rule in the CEP engine, the input data is processed and when the event pattern (=event rule) is met it generates a new event as output. The output of the CEP engine can be reused by other rules for further processing or it can be considered as a final event. Here, the output is a final event and the maintenance tasks are generated for the machines. The way that the events are interpreted is chosen by the user who is defining the CEP rule.

The event message can be dealt with in accordance with the prior art, see, e.g., WO 2019/016148 A1. After receiving an event message from an edge device of the machine, the received event message is matched with maintenance rules to generate at least one maintenance task comprising an associated task description, and a maintenance schedule is provided for the machine assigning the generated maintenance task to suitable maintenance executing entities based on the task description of the respective maintenance task.

In accordance with a further embodiment of the invention, the edge device includes a message broker that receives signals from sensors of the machine and processes the signals before sending them as input data to the complex event processing engine. The message brokers are located near each machine and are used to transfer the signals of the machine, i.e., from its sensors, to the CEP engine. The message broker processes the message and sends only the meaningful events to the CEP engine and to the central application responsible for maintenance.

Each data source, such as a sensor, publishes the signals on a different routing key. The routing key has a certain name or ID that is also stored in the common central configurator, e.g., in a knowledge base, as described subsequently. When a new event rule is deployed, the CEP engine subscribes to a unique routing key to the corresponding data source. The messages sent over the message broker, e.g., have the following format: ID, timestamp, value. The ID is the name of the sensor, the timestamp gives the date when the signal was generated and the value is the value of the signal that is sent by the sensor.

In accordance with a further embodiment of the invention, the common central configurator includes a knowledge base that stores a model of each machine, its data sources, its events and corresponding event rules, whereas new events are stored as new data sources.

The knowledge base is used to model the structure of the monitored system, i.e., the system of the machines. The knowlede base monitors the machines, data sources and CEP rules.

Each machine has one or multiple data sources associated to it. These data sources are, e.g., sensors that are installed on the machine or machine components and provide information on the actual machine status. The meta-data associated with the sensors contains, e.g., a name of the measurement, a name of the sensor and an address from which the data can be read.

The knowledge base models the types of situations that the edge device (here its CEP machine) should detect. Such a type of situation is an event and is characterized by the event rule. In the knowledge base, these situations are modeled as operation types, together with their associated parameters list. After CEP rules are deployed, i.e., when an event rule has been sent to the CEP engines, the model in the knowledge base is updated. This means that event messages from the CEP engines (i.e., the CEP output events) are added as new data source for that class of machine, which event messages can be used for further processing.

In accordance with another embodiment of the invention, the common central configurator includes a user interface for defining an event for a certain class of machines, by using semantic models. Those situations that should be discovered during the monitoring of the machines, the maintenance relevant events, are defined by users. In most cases, users do not know the CEP engine language. Consequently, the interface allows the user to use semantic language for defining the event. The necessary list of parameters is read from the knowledge base and shown to the user on the interface. The respective CEP engine language for that event information is hidden from the user.

Normally, the event rule is defined for a machine class. The user selects the class of machines for which he wants to apply this event rule. The event rule is going to be deployed with the same values for operation type parameters for each machine of that class.

Semantic description helps to bridge the ambiguity of the natural language when expressing notions and their computational representation in a formal language. The semantic description can be based on an ontology of the technical domains of the models. In computer science and information science, an ontology is a formal naming and rule of the types, properties, and interrelationships of the entities that really or fundamentally exist for a particular domain. An ontology compartmentalizes the variables needed for some set of computations and establishes the relationships between them. The semantic description can also include information that do not designate the technical nature, such as the owner of the data or model, the data source or the recording period.

It is possible that, after definition of an event rule, the user also defines a corresponding maintenance rule for this event.

In accordance with yet another embodiment of the invention, the common central configurator includes a rule deployment module that deploys a new event rule for an edge device of at least one machine of this class, preferably for the edge devices of all machines of this class, and which after that updates the model in the knowledge base with the new event rule.

Deployment preferably includes the following four operations:

The event rule for the CEP engine has to contain the format and the name of the new signals that have to be processed for the new event. Thus, it is safeguarded that the CEP engine receives only the data from the selected sensors.

If there is a message broker, then the necessary sensors have to subscribe to the message broker routing key. At the configuration level, the user selects the input data for the event. This data is published on the message broker's routing key. The CEP engine should receive and process the input data. As a result, the sensor should subscribe to the given routing key and send signals to the CEP engine.

The event rule in CEP language is subsequently created and sent to all CEP engines of the machines or machine components of the same class.

The knowledge base model is then updated. If the event generates only intermediate results for further processing, then the selected machine type will have associated a new data item that can be considered a new source of data generated by that machine.

In accordance with another embodiment of the invention, if a machine is reconfigured, then the event rule is automatically updated by amending the model of that machine in the knowledge base and by deploying the new event rule to the respective machines.

A machine reconfiguration is, for example, when one component of a machine is replaced by another component, or if a component is removed, or if a component is added. The user only has to revise the model of this machine in the knowledge base. The common central configurator then updates the model automatically, i.e., the machines and associated data points. Data points associated to the new components can be suggested by the user, based either on the data points of the replaced component of the same type, or based on templates for component classes. The model can be reviewed or adapted and then approved by the user.

The generic event rules are automatically updated when they are not up-to-date, e.g., if an event rule points to components that are not part of a machine anymore. Usually, the parameters of the event rule remain the same and the common central configurator redeploys the event rules on the machines. The parameters are added for installed conmponents and deleted for removed components. All data sources (data points) that are necessary for each event rule are automatically found for each machine.

As such, when a machine is re-configured, the CEP programs in the different edge devices do not need to be re-written manually for each machine, which would not only require a lot of expertise and time but would also be error-prone.

It is also an object of the invention to provide respective computer program code means which means are adapted to perform all the steps of the method according to the invention when the computer program is run on a computer system containing a common central configurator and a multitude of edge devices.

Consequently, when the computer program is run, it prompts a user to define a maintenance relevant event for a certain class of machines by using the common central configurator, then it sends the respective event rule to the edge device of at least one machine of this class, preferably to the edge devices of all machines of this class, it stores the event rule in the edge device and it stores the event rule in the common central configurator.

It is also an object of the present invention to provide a computer system for performing the method in accordance with to the disclosed embodiments of the invention, where the computer system comprises a plurality of machines with edge devices and a common central configurator, where the machines are connected to the common central configurator via edge devices to transfer data, where the common central configurator is configured to allow definition of a maintenance relevant event for a certain class of machines, where the common central configurator is configured to send a respective event rule to an edge device of at least one machine of this class, preferably to the edge devices of all machines of this class, where the edge device forms part of the computer system, and configured to store the event rule, and where the edge devices are also configured to store the event rule.

The disclosed embodiments of the present invention enable machine tool fitters and operators of machine tools to easily define generic rules for generating soft sensors and complex events based on the machine condition. The disclosed embodiments of the present invention provide a knowledge-based configuration of complex events, especially for CNC machine tools, and allows for flexible specification of new complex events and datapoints (e.g., aggregations), it allows definition of generic complex event rules that can be deployed on different machine instances and for different instances of the same component type, it allows automatic re-deployment of complex event rules after a machine is re-configured.

The disclosed embodiments of the present invention are favourably based on a configuration interface embedded into a backend application, e.g., running or executing in the cloud, and a CEP engine running or executing on an edge device that is connected to, e.g., a CNC machine tool.

As complex events can be used in order to automate machine tool maintenance (e.g. by defining maintenance rules such as that every 500,000 clamping cycles of the spindle the clamping unit of the spindle should be re-greased), as well as to improve machine monitoring, the disclosed embodiments of the invention help to reduce maintenance costs, e.g., by reducing fitter working hours, by reducing the time needed for the definition and deployment of maintenance related rules, help to reduce operator or working hours, by performing maintenance based on machine condition instead of maintenance in fixed time intervals, help to reduce costs related to cloud resources, by aggregating data on the edge device and sending only aggregated signals or events to the application running in the cloud, help to reduce spare part costs, by alerting the need for spare part exchange based on machine condition, help to improve general machine condition monitoring, help to increase productive machine hours, and help to improve documentation.

Based on the defined event rules, specific CEP statements are deployed, which detect special situation occurring on the machine status. The common central configurator, which is an event rule configuration framework, is created to simplify the way of defining the event rules. The event rules are used for monitoring the edge devices, i.e., the machine's status in near real time. For example, if there are 100 machines of the same type on the system, then the user has to define only once one rule based on which 100 CEP statements are going to be deployed for monitoring each machine. On the other hand, the event rule configuration framework offers a user-friendly user interface, preferably a Graphical User Interface. The user has to insert only necessary parameter's values based on needed operation without the necessity to have knowledge about a CEP engine and its language. Each machine, i.e., its machine controller, has a set of data, generated by its sensors, which can be read and used as input for its CEP engine. The state of the monitored machine can be detected in near real time.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in closer detail by reference to a preferred embodiment, which is depicted schematically in the figures, in which:

FIG. 1 shows a schematic illustration of a computer system in accordance with the invention;

FIG. 2 shows a user interface for entering a first new event in accordance with the invention;

FIG. 3 shows a user interface for entering a second new event in accordance with the invention;

FIG. 4 shows an event rule model in accordance with the invention;

FIG. 5 shows a semantic model in accordance with the invention; and

FIG. 6 is a flowchart of the method in accordance with the invention.

### DETAILED DESCRIPTION OF THE EXEMPLARY EMBODIMENTS

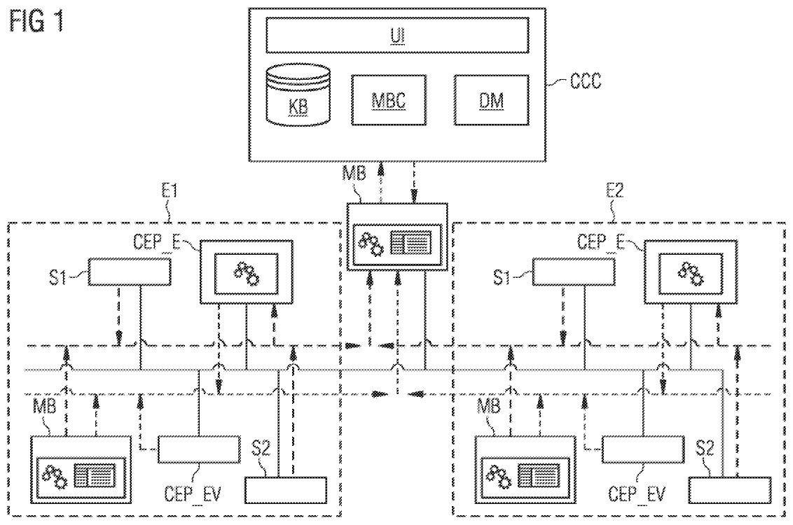

FIG. 1 shows a computer system containing a common central configurator CCC in its function as an event rule configuration framework. The common central configurator CCC contains a CEP rule configuration interface UI, a knowledge base KB, a message broker connector MBC, and a CEP rule deployment module DM.

A plurality of machines, here exemplarily represented by two edge devices E1,E2 (each edge device E1,E2 for one machine), are connected to the common central configurator CCC via the message broker MB of their edge device E1,E2. There is an additional message broker MB in front of the common central configurator CCC, where the message broker MB communicates with the message broker connector MBC of the common central configurator CCC. Every edge device E1,E2 has a CEP engine CEP_E connected to its own and to all other message brokers MB. Every machine or edge device E1,E2, respectively, has two sensors S1,S2 sending their data to the communication system of the message brokers MB, as well as to their own CEP engine CEP_E. The item CEP events (labelled CEP_EV) refers to events generated by the CEP engine CEP_E and published on the message broker MB.

The computer system here is used to monitor the machines and to generate maintenance relevant events based on system status. A maintenance use case is presented based on spindle condition monitoring of a CNC machine, i.e., to generate an event if the average clamping time deviates from a given value in a given period of time. In order to cover condition-based spindle maintenance, two CEP operation types (=event rules) are defined: “Aggregated Cycle Interval” and “Threshold”. The result from the first event rule “Aggregated Cycle Interval” will be used as input to the second event rule “Threshold”.

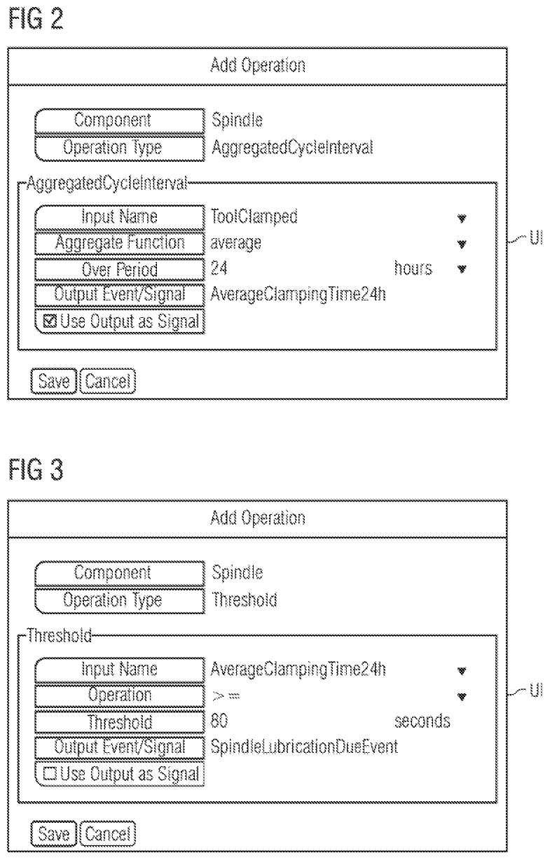

For the first event rule, i.e., “Aggregated Cycle Interval”, the input user interface UI appears as shown in FIG. 2. In a window “Add Operation”, a new event rule can be defined. The user has to define to which component the event rule refers to, here it is the spindle of the CNC machine tool (“Spindle”). The event rule has to be named (under “Operation Type”), here as “AggregatedCycleInterval”. Then the user has to give the name of the data source or signal for the input (under “Input Name”) for the event rule, in this case he chooses the sensor that gives a Boolean value (0 or 1) for the clamping status of the tool (“ToolClamped”). The user chooses how the signal or data shall be aggregated (under “Aggregate Funktion”), here “average”. Accordingly, the user has to define the period for aggregation (under “Over Period”), here “24” and the time unit, here “hours”. The user could also choose other aggregate functions, such as a sum, or minimal or maximal values. The user names the output event or signal (under “Output Event/Signal”), here the chosen name is “AverageClampingTime24h”. This first event rule generates an event that is used for further processing thus the box for “Use Output as Signal” is checked.

By clicking “Save”, the new event rule is saved, translated into CEP language and sent to the CEP engines CEP_E of the machines M1,M2 over the CEP rule deployment module DM and the message brokers MB (see FIG. 1). Then the new event rule “Aggregated Cycle Interval” is saved in the knowledge base KB. The event “Aggregated Cycle Interval” is generated every 24 hours, and it contains the value of the average time between spindle clamping cycles.

The first event rule, i.e., “Aggregated Cycle Interval”, is used to detect the average of the period between spindle cycles. This event rule will not generate final events.

For the second event rule “Threshold” the input user interface UI appears as shown in FIG. 3. As in FIG. 2, there is a window “Add Operation” where the new event rule can be defined. The user has to define to which component the event rule refers, here it is again the spindle of the CNC machine tool (“Spindle”). The event rule has to be named (under “Operation Type”), here as “Threshold”. Then the user has to give the name of the data source or signal for the input (under “Input Name”) for the event rule, in this case he chooses the output of the first event rule or operation type “AverageClampingTime24h”. The first event rule yields a number. Accordingly, the possible operation (under “Operation”) that are offered by the user interface UI and that can be chosen is for comparing values, here <, >, <=, >=. Here the user chooses “>=”. The user then has to choose a threshold value (under “Threshold”), here he chooses “80” seconds. The user names the output event or signal (under “Output Event/Signal”), here the chosen name is “SpindleLubricationDueEvent”. This second event rule generates an event that is not used for further processing thus the box for “Use Output as Signal” is not checked.

By clicking “Save”, the new event rule is saved, translated into CEP language and sent to the CEP engines CEP_E of the machines M1,M2 over the CEP rule deployment module DM and the message brokers MB (see FIG. 1).

The second event rule “Threshold” gives an event when the average spindle clamping time over 24 hours exceeds 80 seconds. The generated event message of the event “SpindleLubricationDueEvent” has the following format:

ID number

date and time

Event Type: SpindleLubricationDueEvent

Affected Component: 45AX-Spindle

Affected Component Label: Spindle

Measurement: SpindleLubricationSpindleLubricationDueEvent

Value: 9.00275

Unit: seconds

This event message can be forwarded to the suitable maintenance executing entities.

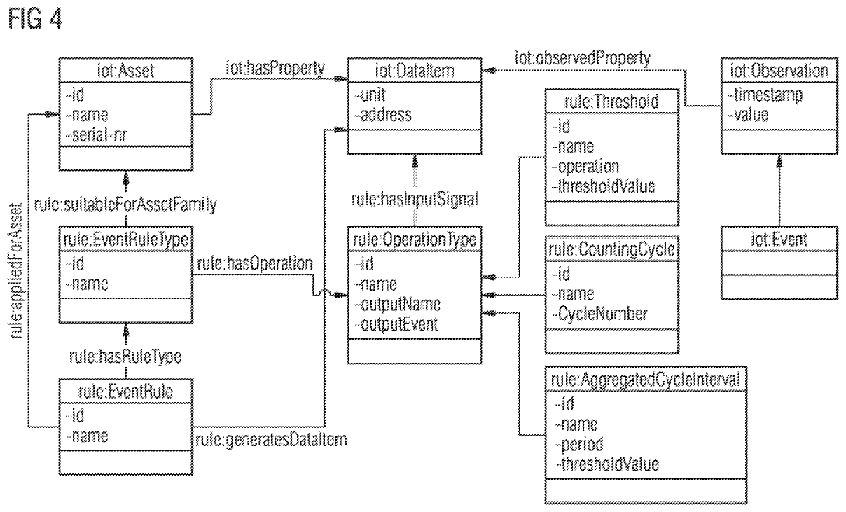

FIG. 4 depicts an event rule model for asset and data item classes. An asset can be a machine or a machine component that shall be monitored and for which event rules are created. Each asset item (“Iot:Asset”) has a unique identification, such as an ID number, for the computer system, a name (for display on the user interface UI) and a serial number (of the physical device). Thus, the asset here could be the spindle. This event rule model will be stored in the knowledge base KB of the common central configurator CCC.

As properties of the asset (“Iot:hasProperty”) different data can be assigned, here one data item “Iot:DataItem” is present, containing a unit and an address.

An event rule item (“rule:EventRule”) with a certain ID and name points (“rule:hasRuleType”) to a rule type item (“rule:EventRuleType”) with a certain ID and name. The rule type item is linked to the asset item, if it is suitable for this type of asset (“rule:suitableForAssetFamily”), i.e., for this class of machine or this class of machine component. The rule type item is also linked (“rule:hasOperation”) to a rule item relating to the operation type (“rule:OperationType”), the operation type containing an ID, a name, an output name and an output event. The rule item relating to the operation type points (“rule:haslnputSignal”) to the data item “Iot:DataItem”.

The event rule item (“rule:EventRule”) also points (“rule:generatesDataItem”) to the data item and points (“rule:appliedForAset”) to the asset item.

The data item receives (“Iot:observedProperty”) observation data from the observation item (“Iot:Observation”), where each observation contains a timestamp and a value and is triggered by an event item (“Iot:Event”).

Here, three different rules point to the operation type item (“rule:OperationType”): the threshold rule item (“rule:Threshold”) containing an ID, a name, an operation and a treshold value, see FIG. 3; the counting cycle item (“rule:CountingCycle”) containing an ID, a name and a cycle number; the item for aggregated cycle interval (“Rule:AggregatedCycleInterval”) containing an ID, a name, a period and a threshold value, see FIG. 2.

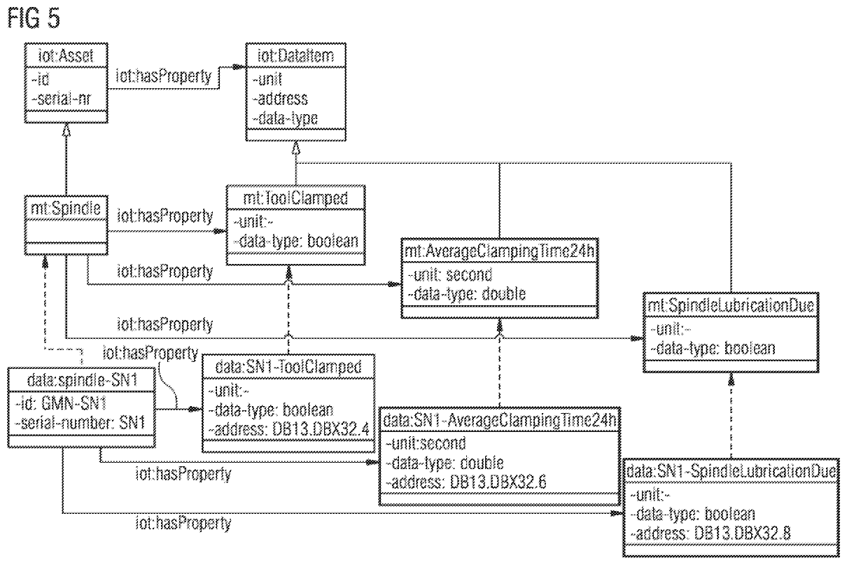

FIG. 5 depicts a semantic model of the spindle class and its data items. The spindle class (for spindles all having the same mechanical and technical properties) are defined in the asset item (“Iot:Asset”) by an ID and a serial number. This item points (“Iot:hasProperty”) to the data item (“Iot:DataItem”) that contains information about the unit, the address in the system and the data type of this data.

The data of a certain spindle SN1 is defined in a respective item (“data:spindle-SN1”) and contains an ID “GMN-SN1” for identification within the computer system and a serial number SN1. This data item points to the general spindle item (“mt:Spindle”), which again points to the asset item. The general spindle item (“mt:Spindle”) at the beginning additionally points (“Iot:has Property”) only to one property item for the clamped tool (“mt:ToolClamped”), where the general spindle item contains information about the unit and the Boolean data type according to which the tool is clamped or not. The item for the clamped tool points to the data item (“Iot:DataItem”). Accordingly, the spindle data item (“data:spindle-SN1”) also points (“Iot:has Property”) to its tool clamped item (“data:SN1-ToolClamped”) that contains a unit, a concrete data type (Booelan) and a concrete address: DB13.DBX32.4. The tool clamped item of the concrete spindle SN1 points to the general item for the clamped tool (“mt:ToolClamped”).

Now, when the user defines a new event rule “Aggregated Cycle Interval” with the output event or signal “AverageClampingTime24h”, see FIG. 2, then this output event is added both as a new general item “mt:AverageClampingTime24h” to the properties of the general spindle item (“mt:Spindle”), parallel to the existing clamped tool item (“mt:ToolClamped”), and as a new item “data:SN1-AverageClampingTime24h” to the concrete spindle item (“data:spindle-SN1”), parallel to the existing data item. The concrete spindle item “data:spindle-SN1-AverageClampingTime24h” contains the unit of the data, here seconds, the data type, here double, and the concrete address DB13.DBX32.6, and points to the general item “mt:AverageClampingTime24h”.

When the user defines the new event rule “Threshold” with the output event or signal “SpindleLubricationDueEvent”, see FIG. 3, then this output event is added both as a new general item “mt:SpindleLubricationDue” to the properties of the general spindle item (“mt:Spindle”), parallel to the two existing property items, and as a new item “data:SN1-SpindleLubricationDue” to the concrete spindle item (“data:spindle-SN1”), parallel to the existing data item. The concrete spindle item “data:SN1-SpindleLubricationDue” contains the unit of the data, here no units, the data type, here Boolean, and the concrete address DB13.DBX32.8, and points to the general item “mt:SpindleLubricationDue”.

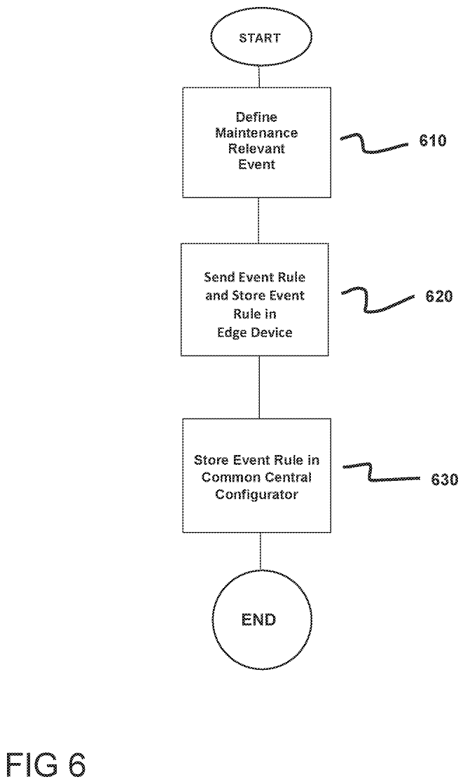

FIG. 6 is a flowchart of the method FIG. 6 is a flowchart of a method for implementing event rules for maintenance relevant events in a plurality of machines, where the method utilizes a computer system containing a common central configurator CCC, and the plurality of machines are connected to the common central configurator to transfer data. The method comprises defining a maintenance relevant event for a class of machines by utilizing the common central configurator CCC, as indicated in step 610.

Next, an event rule is sent to an edge device E1,E2 of at least one machine of the class of machines and storing the event rule is stored in the edge device E1,E2, as indicated in step 620. In accordance with the invention, the edge device E1,E2 forms part of the computer system.

Next, the event rule is stored in the common central configurator CCC, as indicated in step 630.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for implementing event rules for maintenance relevant events in a plurality of machines, the method utilizing a computer system containing a common central configurator, the plurality of machines being connected to the common central configurator to transfer data, the method comprising:
defining a maintenance relevant event for a class of machines by utilizing the common central configurator;
sending an event rule to an edge device of at least one machine of said class of machines and storing the event rule in the edge device, the edge device forming part of the computer system; and
storing the event rule in the common central configurator.

12. The method according to claim 11, wherein the edge device is situated at or near the at least one machine and the common central configurator comprises a cloud service.

13. The method according to claim 11, wherein the edge device includes a complex event processing engine which, based on the event rule and based on input data from the at least one machine, creates an event message if the input data fulfills the event rule and sends the event message to a device which deploys a respective maintenance rule.

14. The method according to claim 12, wherein the edge device includes a complex event processing engine which, based on the event rule and based on input data from the at least one machine, creates an event message if the input data fulfills the event rule and sends the event message to a device which deploys a respective maintenance rule.

15. The method according to claim 13, wherein the edge device includes a message broker (MB) which receives signals from sensors of the at least one machine and processes the signals before sending said processed signals as input data to the complex event processing engine.

16. The method according to any claim 11, wherein the common central configurator includes a knowledge base which stores a model of each machine, data sources of each machine, events and corresponding event rules of each machine; and wherein new events are stored as new data sources.

17. The method according to claim 11, wherein the common central configurator includes a user interface for defining an event for a certain class of machines by utilizing semantic models.

18. The method according to claim 16, wherein the common central configurator includes a deployment module which deploys a new event rule for an edge device of at least one machine of this class, preferably for the edge devices of all machines of this class, and which subsequently updates the model in the knowledge base with the new event rule.

19. The method according to claim 16, wherein if a machine is reconfigured the event rule is automatically updated by amending the model of said machine in the knowledge base and by deploying the new event rule to respective machines.

20. The method according to claim 11, wherein the event rule is sent to edge devices of all machines of the class.

21. The method according to claim 18, wherein the new event rule is deployed for edge devices of all machines of said class.

22. Computer program code means adapted to perform the method of claim 11 when the computer program is executed on a computer system containing a common central configurator and a plurality of edge devices.

23. A computer system for implementing event rules for maintenance relevant events, the computer system comprising:
a plurality of machines with edge devices; and
a common central configurator, the plurality of machines being connected to the common central configurator via edge devices to transfer data;
wherein the common central configurator is configured to allow definition of a maintenance relevant event for a class of machines;
wherein the common central configurator is configured to send a respective event rule to an edge device of at least one machine of said class of machines and configured to store the event rule;
wherein the edge device forms part of the computer system; and
wherein the edge device is configured to store the event rule.

24. The computer system according to claim 23, wherein the respective event rule is sent to edge devices of all machines of said class.
